(19) United States
(12) Patent Application Publication
(10) Pub. No.: US 2017/0316179 A1
(43) Pub. Date: Nov. 2, 2017

(54) SYSTEMS AND METHODS FOR PRESCRIBED EXERCISE MONITORING

(71) Applicant: The Board of Regents of the University of Texas System, Austin, TX (US)

(72) Inventor: Robert J. DIMEFF, Dallas, TX (US)

(21) Appl. No.: 15/581,727

(22) Filed: Apr. 28, 2017

Related U.S. Application Data
(60) Provisional application No. 62/329,356, filed on Apr. 29, 2016.

(51) Int. Cl. G06F 19/00; G06Q 10/06; G06Q 50/22

(52) U.S. Cl. CPC G06F 19/3481; G06Q 50/22; G06F 19/3418; G06Q 10/06

(57) ABSTRACT

Systems and methods for monitoring performance of prescribed exercises. Particular embodiments allow clinicians and other exercise experts the ability to qualitatively and quantitatively follow compliance outside of subjective reporting, of the individual performing the prescribed exercises by accurately assessing range of motion, speed and path efficiency.

### CROSS-REFERENCE TO RELATED APPLICATION

This application claims priority to U.S. Provisional Patent Application Ser. No. 62/329,356 filed Apr. 29, 2016, the entire contents of which are incorporated herein by reference.

### BACKGROUND

Exemplary embodiments of the present invention relate generally to the fields for monitoring overall exercise motions. More particularly, exemplary embodiments concern monitoring motions associated with rehabilitative exercises.

People who become injured either acquire a bone, muscle or some other form of soft tissue disease. Whether they will either undergo surgery or be treated non-operatively. In either situation, these patients will require meticulous rehabilitation. Some of the most important aspects of rehabilitation are repetitive and accurate exercises in order to recover or heal properly. Injury and/or incorrect healing can arise when patients do not use the correct form while performing the exercises outside of direct supervision of the licensed therapist. Therapists and patients alike would both benefit with the ability to ensure both quantitative rehabilitation compliance while performing quality exercise movements. Additionally, the ability to accurately assess and monitor motions related to sport and exercise skills can be improved by providing instant feedback to the individual.

### SUMMARY

Exemplary embodiments of the present disclosure include a take-home physical therapy monitoring device that can accurately detect exercises assigned by the physical therapists and determine/communicate to the patient how effectively the exercise is being performed. In order to analyze the patient's exercises, three main parameters are highlighted: speed of repetitions, range of motion, and path efficiency. These three metrics were deemed the top three values physical therapists use to quantify and evaluate exercise movements. Speed is measured in repetitions per second and is imperative with exercise due to increased risk of injury or lack of quality movements when speed is performed too slow or too fast. Range of motion is the measurement around a specific joint that the patient is reaching during exercise. This parameter is important because too little motion will not benefit the patient's improved health and too much range may cause injury. Lastly, path efficiency is described as how well the patient is moving in the intended plane(s). These metrics will be used to: recognize movements, generate reports for the physical therapist, and give immediate patient feedback via applications that can be downloaded on external devices. In certain embodiments, the application and technology that communicates from the device to the smart phone via wireless communication may be developed by third parties, including for example, Rithmio based in Chicago, Ill. In exemplary embodiments, the reporting is compliant with the Health Insurance Portability and Accountability Act of 1996 (HIPPA) and is transferred securely either through a USB cable or Wifi/Bluetooth technology for patients utilizing this device. These metrics can also be used to monitor and provide feedback for proper performance and sport and exercise movement in noninjured, normal individuals and sportsmen.

Exemplary embodiments of this disclosure include two main aspects: hardware and software. The hardware portion can include a motion platform board with a microcontroller, microprocessor, accelerometer, gyrometer, battery, serial flash and Bluetooth radio. The hardware portion may also include a case for the system on a computer microchip complete with a comfortable band/wrap. Software can be used to calculate and display the three parameters while the patient is exercising in order to provide immediate feedback via an external device. The system allows patients to record their form alongside the physical therapist, creating a baseline for at home or un-supervised rehabilitation. This system also allows those participating in an exercise activity and their advisors to instantly monitor the accuracy of their movements.

Exemplary embodiments can be used beneficially for an extensive variety of physically active patients. This wearable device will track and stream the movement data of the exercises to a mobile application that will record and report the data to the patient, physical therapist, athletic trainer, coaches, and others involved in advising the individual.

Exemplary embodiments include a clinically viable wearable sensor (CVWS) that has the ability to measure and evaluate a patient based on several metrics that have been defined through algorithms. These metrics have been defined by a variety of clinicians as the more important aspects of prescribed movements in the treatment of patients with musculoskeletal injuries. These include the monitoring of: range of motion, path efficiency, speed of exercise, rest intervals, number of repetitions and sets, and frequency of exercise. These metrics will be used to; recognize movements, generate reports for the physical therapist and other exercise experts, and give immediate patient feedback via applications that can be downloaded on a variety of external devices.

Exemplary embodiments include a system for monitoring prescribed exercises. In certain embodiments, the system comprises: a sensor configured to detect a plurality of motions in three-dimensional space, where the plurality of motions comprise prescribed exercises performed by a person; a processor configured to process input data from the sensor, wherein said input data is associated with the a plurality of motions; and a wireless communication module configured to receive data from the processor and transmit output data.

Particular embodiments further comprise a monitoring device, where the monitoring device is configured to receive output data from the wireless communication module; and the monitoring device comprises a graphical display configured to display feedback regarding the prescribed exercise. In some embodiments, the feedback comprises a speed of a motion detected by the sensor, a range of a motion detected by the sensor and/or a path efficiency of a motion detected by the sensor. In specific embodiments, the feedback is calculated by comparing a motion detected by the sensor to a baseline motion.

In certain embodiments, the baseline motion is recorded by the system when the person is in the presence of a third party. In particular embodiments, the sensor comprises a three-axis gyroscope. In some embodiments, the sensor comprises a three-axis accelerometer and/or a three-axis magnetometer. Specific embodiments further comprise a coupling mechanism configured to couple the sensor to the person. In certain embodiments, the coupling mechanism comprises an elastic strap, and in some embodiments, the sensor is contained in a housing comprising an orientation indication.

Particular embodiments include a method for monitoring rehabilitative exercises. In exemplary embodiments, the method comprises: detecting a first plurality of motions by a person in three-dimensional space, where the first plurality of motions comprise prescribed exercises performed in the presence of a third party; establishing baseline parameters from the first plurality of motions; detecting a second plurality of motions by the person in three-dimensional space, wherein the second plurality of motions comprise prescribed exercises; comparing the second plurality of motions to the baseline motions; and displaying feedback regarding differences between the second plurality of motions and the baseline parameters.

In some embodiments, the third party is a physical therapist or other exercise expert. In particular embodiments, the baseline parameters comprise a range of motion parameter, a speed parameter and/or a path efficiency parameter. In certain embodiments, data relating to the feedback is wirelessly transmitted from a communication module coupled to the person to a display device viewed by the person. In particular embodiments, data relating to the feedback is wirelessly transmitted from a communication module coupled to the person to a display device viewed by the third party. In some embodiments, the display device is a computer, tablet or wireless phone.

In certain embodiments, the first plurality of motions are detected by a first sensor and the second plurality of motions are detected by a second sensor. In particular embodiments, the first plurality of motions and the second plurality of motions are each detected by a first sensor. In some embodiments, the first sensor comprises a three-axis gyroscope, a three-axis accelerometer, and/or a three-axis magnetometer. Certain embodiments further comprise coupling the first sensor to the person via a coupling mechanism. In particular embodiments, the coupling mechanism comprises an elastic strap. In specific embodiments, the first sensor is contained in a housing comprising an orientation indication.

Any embodiment discussed with respect to one aspect of the invention applies to other aspects of the invention as well.

The embodiments in the one section of this disclosure are understood to be embodiments of the invention that are applicable to all aspects of the invention, including those in other sections of the disclosure.

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the standard deviation of error for the device or method being employed to determine the value.

Following long-standing patent law, the words “a” and “an,” when used in conjunction with the word “comprising” in the claims or specification, denotes one or more, unless specifically noted.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The terms “substantially” and “generally” are defined as largely but not necessarily wholly what is specified (and includes what is specified; e.g., substantially 90 degrees includes 90 degrees and generally parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a device for removal of calculus, or a component of such a device, that is configured in a certain way is configured in at least that way, but it can also be configured in other ways than those specifically described.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 shows a perspective view of components of exemplary embodiments of systems according to the present disclosure.

FIG. 2 shows a top view of an integrated circuit of an exemplary embodiment according to FIG. 1.

FIG. 3 shows a graphical display of a first display device of an exemplary embodiment according to FIG. 1.

FIG. 4 shows a graphical display of a second display device of an exemplary embodiment according to FIG. 1.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

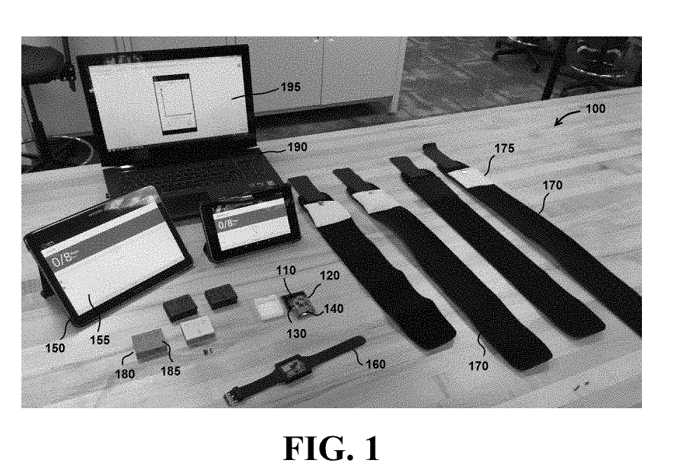

Referring now to FIG. 1, various components and embodiments of a system 100 for monitoring rehabilitative and general exercises are shown. The embodiments shown include an integrated circuit 110 comprising a sensor 120, a processor 130 and a wireless communication module 140. In exemplary embodiments, sensor 120 is configured to detect a plurality of motions in three-dimensional space comprising rehabilitative and exercise movements performed by a person. In this embodiment, processor 130 is configured to process input data associated with the plurality of motions from sensor 120. In addition, wireless communication module 140 is configured to receive data from processor 130 and transmit output data to a monitoring device 150 that comprises a graphical display 155 configured to display feedback to the user regarding the exercises while they are being performed in real time. In the embodiment shown, system 100 also comprises a monitoring device 190 with a graphical display 195 that can be configured to provide feedback to a physical therapist or other expert regarding the user's performance of the prescribed exercises.

In exemplary embodiments, integrated circuit 110 (with the associated components, including sensor 120) are contained in a housing 180 comprising an orientation indication 185. Orientation indication 185 provides an indication for a user to properly orient housing 180 so that sensor 120 can be oriented in the preferred position to properly detect the motion associated with the prescribed exercises. System 100 can also comprise a coupling mechanism configured to couple sensor 120 to a person performing the prescribed exercises. In particular embodiments, the coupling mechanism may be configured as a watch band 160 or an elastic strap 170.

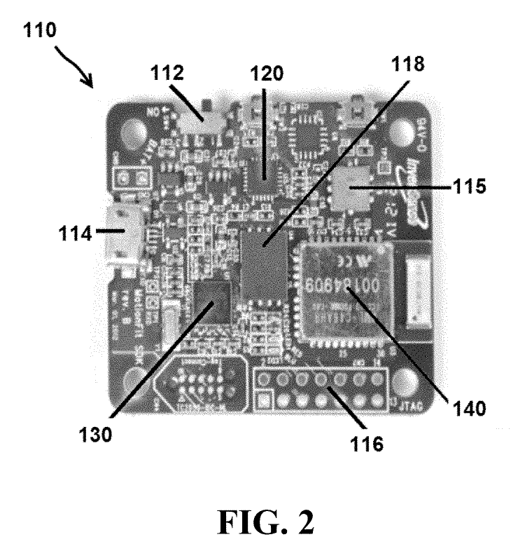

Referring now to FIG. 2, a view of one embodiment of integrated circuit 110 shows sensor 120, processor 130 and wireless communication module 140. In the embodiment shown, integrated circuit 110 also comprises an on/off switch 112, a micro USB connection 114, a pressure sensor 115, a processing module 116, and a serial flash 118. A rechargeable battery, charged via micro USB 114, can be used to power integrated circuit 110. It is understood that the components shown in FIG. 2 are merely exemplary of one embodiment, and other embodiments may have different components within integrated circuit 110.

In particular embodiments, sensor 120 may comprise a 3-axis gyroscope, 3-axis accelerometer, and 3-axis magnetometer. In one specific embodiment, sensor 120 may be an InvenSense® MPU 9150 sensor. In certain embodiments, wireless communication module 140 may be configured as a Bluetooth® Low Energy (BLE) module that allows system 100 to connect to a mobile device through an application to stream and display the data.

During use, coupling mechanism 170 (including integrated circuit 110 in housing 180) can initially be coupled to a user while exercises are being performed under the supervision of a third party. In particular embodiments, the third party may be a physical therapist or other expert in the field capable of supervising the user in the preferred technique of the exercise movements. In certain embodiments, coupling mechanism 170 may be formed from an elastic material, including for example, neoprene. The elasticity of the material can allow coupling mechanism 170 to easily conform to the user (e.g. at the thigh and the ankle) in a desired orientation. In certain embodiments, coupling mechanism 170 may comprise a pocket 175 to secure housing 180 (and integrated circuit 110) to the user. In particular embodiments, pocket 175 may be waterproof to reduce the likelihood of damage due to moisture (e.g. sweat).

Coupling sensor 120 to a user while exercises are being performed under the supervision of a third party can allow a user to establish baseline parameters for the prescribed exercises. These baseline parameters can be used for comparative purposes when the user subsequently performs the prescribed exercises without the supervision of the expert. In certain examples, the same sensor can be used to establish the baseline prescribed exercise parameters and to monitor the subsequent exercise performed by the individual. This can minimize discrepancies in equipment calibration and provide for accurate feedback. In other embodiments, however, different sensors may be used to establish these baseline prescribed exercise parameters and monitor the subsequent exercise performance.

In one exemplary embodiment, baseline parameters for each prescribed exercise can be established based on various criteria, including for example, speed, range of motion, and path efficiency. As used herein, the speed of an exercise is calculated using the time of repetition for the exercise, the range of motion is calculated using the distance moved by the user in the main plane of motion, and the path efficiency is calculated using distance moved by user in planes of least motion.

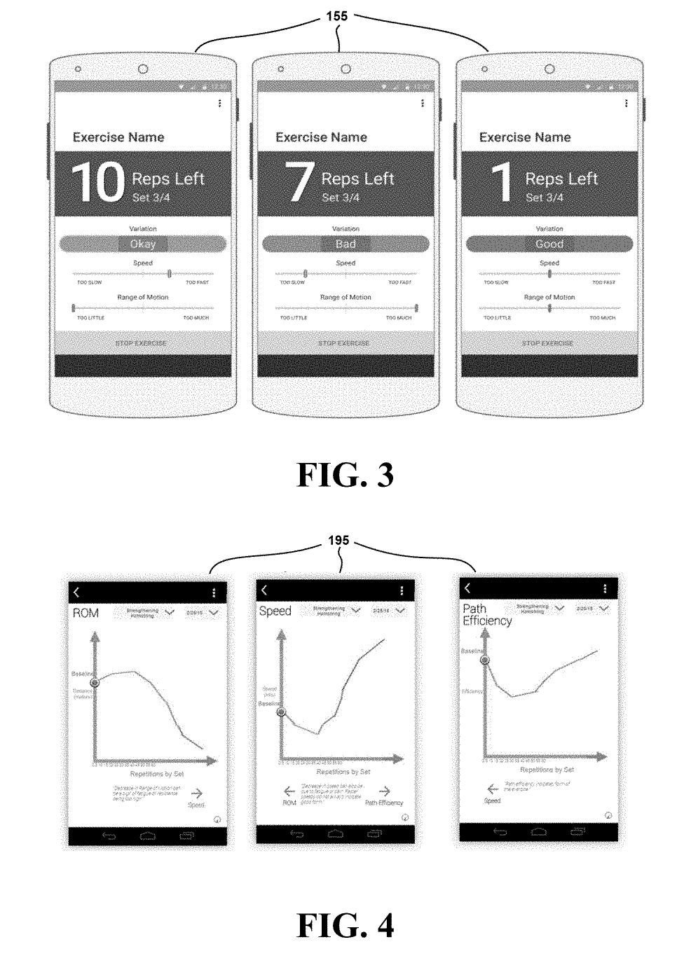

After the baseline parameters have been established, system 100 can be used to monitor subsequent prescribed exercises performed by the user (e.g. the person performing such exercises). For example, system 100 can provide feedback to the user and the expert by comparing a motion detected by sensor 120 (without expert supervision) to the baseline parameters (established under expert supervision). In particular embodiments, monitoring device 150 can provide feedback via graphical display 155 regarding the specified criteria. Referring to FIG. 3, for example, graphical display 155 can indicate that a user is performing at the baseline (e.g. “target”) speed, or if the user is performing the exercise too slow or too fast. The graphical display 155 can also indicate qualifications relating the baseline criteria such as “Okay”, “Bad” or “Good”. Additionally, this display provides a visual color scheme to assess the quality of movement (e.g. “yellow”=“Okay”, “red”=“Bad”, “green”=Good). Graphical display 155 can also provide feedback to the user is performing the exercise within the baseline range of motion, or if the user is performing the exercise with too little or too much range of motion.

In addition to graphical feedback to the person performing the prescribed exercises, system 100 can also provide graphical feedback to the physical therapist or other expert monitoring the user's performance. Referring now to FIG. 4, examples of graphical display 195 are shown for range of motion, speed and efficiency parameters. The embodiments shown can be used by the physical therapist or other expert to evaluate how closely the user is performing an exercise in comparison to their baseline parameters. In the particular embodiments shown in FIG. 4, a physical therapist or other expert monitoring the user's performance is provided a graphical display of the parameter over a number of repetitions of the exercise. As shown in FIGS. 3 and 4, the graphical displays and user interfaces are designed to be simple and easy to navigate for both the individual performing the prescribed exercises and the expert.

System 100 can therefore provide real-time feedback to a user regarding his or her performance when performing the prescribed exercises. This can allow the user to correct deficiencies in form or speed while the exercise is being performed. Accordingly, the effectiveness of the prescribed exercises can be increased by maintaining proper form and speed. Feedback data can also be stored for review by the user after the prescribed exercises are completed.

In addition to user feedback, system 100 can provide feedback (either real time or stored) to a third party, e.g. an expert supervising the exercise program for the user. This can allow the third party to remotely monitor the user's performance of the prescribed exercises without physically being present. Such capabilities can reduce both time and costs associated with prescribed exercise programs by eliminating the need for the user or supervisor to travel from various locations. User accountability can be promoted with constant reports that are sent back to the third party expert.

In addition, the system can be reprogrammed at any time to modify, add or delete other exercises under the guidance of the physical therapist or other expert as the individual masters the prescribed exercises

Component Specifications

The following component specifications are provided for illustrative purposes for one exemplary embodiment. It is understood that other exemplary embodiments can comprise components with specifications other than those provided below.

As previously mentioned, sensor 120 can be configured as InvenSense® MPU 9150 sensor. The MPU 9150 is a 9-axis MotionTracking device designed for the low power, low cost, and high-performance requirements of consumer electronics equipment including smartphones, tablets, and wearable sensors. The MPU-9150 is a System in Package (SiP) that combines two chips: the MPU-6050, which contains a 3-axis gyroscope, 3-axis accelerometer, and an onboard Digital Motion Processor™ (DMP™) capable of processing complex MotionFusion algorithms; and the AK8975, a 3-axis digital compass. The part's integrated 6-axis MotionFusion algorithms access all internal sensors to gather a full set of sensor data. The part is offered in a 4×4×1 mm LGA package and is upgrade-compatible with the MPU-6050™ integrated 6-axis MotionTracking device, providing a simple upgrade path and making it easy to fit on space constrained boards. For precision tracking of both fast and slow motions, the parts feature a user-programmable gyro full-scale range of ±250, ±500, ±1000, and ±2000°/sec (dps), a user-programmable accelerometer full-scale range of ±2 g, ±4 g, ±8 g, and ±16 g, and compass with a full scale range of ±1200 μT.

In certain embodiments, housing 180 may be formed from a 3D printed case made from ABS-M30 to provide protection for the MPU 9150.

All patents, patent applications, and published references cited herein are hereby incorporated by reference in their entirety. While the devices and methods of the present disclosure have been described in connection with the specific embodiments thereof, it will be understood that they are capable of further modification. Furthermore, this application is intended to cover any variations, uses, or adaptations of the devices and methods of the present disclosure, including such departures from the present disclosure as come within known or customary practice in the art to which the devices and methods of the present disclosure pertain.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms about, substantially, generally, and approximately (and variations thereof) as used herein, are defined as at least approaching a given state. In specific embodiments, the terms may be defined as being largely but not necessarily wholly what is specified as understood by one of ordinary skill in the art, and in one non-limiting embodiment refers to ranges within 10%, preferably within 5%, more preferably within 1%, and most preferably within 0.5% of what is specified.

The term prescribed exercise, as used herein, is defined as a movement performed by a person based upon the instruction of a third party, including for example, exercise experts and physical therapists. Specific examples of prescribed exercises include, but are not limited to, exercises performed by a person for the purpose of rehabilitating a bodily function performed by the person, including movement of a limb, torso, head, or appendage. Additional examples include, but are not limited to, exercises performed by a person to enhance athletic performance.

Furthermore, all the disclosed elements and features of each disclosed embodiment can be combined with, or substituted for, the disclosed elements and features of every other disclosed embodiment except where such elements or features are mutually exclusive.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

1. A system for monitoring prescribed exercises, the system comprising:
a sensor configured to detect a plurality of motions in three-dimensional space, wherein the plurality of motions comprise prescribed exercises performed by a person;
a processor configured to process input data from the sensor, wherein said input data is associated with the a plurality of motions; and
a wireless communication module configured to receive data from the processor and transmit output data.

2. The system of claim 1 further comprising a monitoring device, wherein:
the monitoring device is configured to receive output data from the wireless communication module; and
the monitoring device comprises a graphical display configured to display feedback regarding the prescribed exercise.

3. The system of claim 2 wherein the feedback comprises a speed of a motion detected by the sensor.

4. The system of claim 2 wherein the feedback comprises a range of a motion detected by the sensor.

5. The system of claim 2 wherein the feedback comprises a path efficiency of a motion detected by the sensor.

6. The system of claim 2 wherein the feedback is calculated by comparing a motion detected by the sensor to a baseline motion.

7. The system of claim 6 wherein the baseline motion is recorded by the system when the person is in the presence of a third party.

8. The system of claim 1 wherein the sensor comprises a three-axis gyroscope.

9. The system of claim 1 wherein the sensor comprises a three-axis accelerometer.

10. The system of claim 1 wherein the sensor comprises a three-axis magnetometer.

11. The system of claim 1 further comprising a coupling mechanism configured to couple the sensor to the person.

12. The system of claim 11 wherein the coupling mechanism comprises an elastic strap.

13. The system of claim 12 wherein the sensor is contained in a housing comprising an orientation indication.

14. A method for monitoring rehabilitative exercises, the method comprising:
detecting a first plurality of motions by a person in three-dimensional space, wherein the first plurality of motions comprise prescribed exercises performed in the presence of a third party;
establishing baseline parameters from the first plurality of motions;
detecting a second plurality of motions by the person in three-dimensional space, wherein the second plurality of motions comprise prescribed exercises;
comparing the second plurality of motions to the baseline motions; and
displaying feedback regarding differences between the second plurality of motions and the baseline parameters.

15. The method of claim 14 wherein the third party is a physical therapist or other exercise expert.

16. The method of claim 14 wherein the baseline parameters comprise a range of motion parameter.

17. The method of claim 14 wherein the baseline parameters comprise a speed parameter.

18. The method of claim 14 wherein the baseline parameters comprise a path efficiency parameter.

19. The method of claim 14 wherein data relating to the feedback is wirelessly transmitted from a communication module coupled to the person to a display device viewed by the person.

20. The method of claim 14 wherein data relating to the feedback is wirelessly transmitted from a communication module coupled to the person to a display device viewed by the third party.

21. The method of claim 19 wherein the display device is a computer, tablet or wireless phone.

22. The method of claim 14 wherein the first plurality of motions are detected by a first sensor and the second plurality of motions are detected by a second sensor.

23. The method of claim 14 wherein the first plurality of motions and the second plurality of motions are each detected by a first sensor.

24. The method of claim 23 wherein the first sensor comprises a three-axis gyroscope.

25. The method of claim 23 wherein the first sensor comprises a three-axis accelerometer.

26. The method of claim 23 wherein the first sensor comprises a three-axis magnetometer.

27. The method of claim 23 further comprising coupling the first sensor to the person via a coupling mechanism.

28. The method of claim 27 wherein the coupling mechanism comprises an elastic strap.

29. The method of claim 23 wherein the first sensor is contained in a housing comprising an orientation indication.
